(19) United States
(12) Patent Application Publication
(10) Pub. No.: US 2013/0192988 A1
(43) Pub. Date: Aug. 1, 2013

(54) GAS SENSOR ELEMENT AND GAS SENSOR

(71) Applicant: NGK SPARK PLUG CO., LTD., Nagoya-shi (JP)

(72) Inventors: Koji SHIONO, Komaki-shi (JP); Naoki YAMADA, Iwakura-shi (JP); Kunio IMAI, Unuma-shi (JP)

(73) Assignee: NGK SPARK PLUG CO., LTD., Nagoya-shi (JP)

(21) Appl. No.: 13/670,386

(22) Filed: Nov. 6, 2012

(30) Foreign Application Priority Data
Nov. 8, 2011 (JP) 2011-244252

(51) Int. Cl. G01N 27/407

(52) U.S. Cl. CPC G01N 27/4071; G01N 27/4077
USPC 204/424

(57) ABSTRACT

A gas sensor element in which an adhesion layer (101) securing the adhesion of a sensing electrode (62) and protection layer (67) satisfies the following prescriptions (1) to (3): (1) when the number of raised portions (102) formed per mm² on a surface of a base portion (103) is taken to be N, then 10≦N≦50; (2) when the average of the heights of the raised portions (102) protruding above the surface of the base portion (103) in a direction perpendicular to the surface of the base portion (103) is taken to be H, then 55≦H≦75 [μm]; and (3) when the outer diameter of the raised portions (102) is taken to be D, the number of raised portions (102) with 45<D<90 [μm] is 70% or more of the total number of raised portions (102).

### TECHNICAL FIELD

The present invention relates to a gas sensor element and gas sensor which detect a specified gas component contained in gas to be measured.

### BACKGROUND ART

A gas sensor element whose output changes in accordance with the concentration of a specified gas component in exhaust gas discharged from an internal-combustion engine such as an automobile engine is known. For example, a gas sensor element whose output changes in accordance with an oxygen concentration has a structure in which a pair of electrodes (an outer side electrode and an inner side electrode) are provided on the outer surface and inner surface of a solid electrolyte body formed in a bottomed cylindrical shape. Further, an electromotive force generated between the two electrodes in accordance with a difference in oxygen concentration between exhaust gas, to which is exposed the outer side electrode provided on the outer surface, and reference gas, to which is exposed the inner side electrode provided on the inner surface, is extracted as an output of the gas sensor element.

A protection layer for protecting the outer side electrode from being poisoned by exhaust gas is provided on the gas sensor element. Further, it is known that a rugged shape is provided to the outer surface of the solid electrolyte body in order to enhance the adhesion of the outer side electrode and protection layer (for example, refer to Patent Documents 1 and 2). The rugged shape is formed using a material the same as that of the solid electrolyte body. Specifically, the outer surface of the solid electrolyte body is coated with paste in which are contained large-diameter granular particles (large particles), which are the source of the rugged shape, and microscopic particles (small particles), which enhance the anchoring properties of the granular particles. The paste is co-fired with the solid electrolyte body. Whereby the granular particles take on a form in which the granular particles protrude from a layer of the microscopic particles, and are formed integrally with the solid electrolyte body.

When the solid electrolyte body outer surface on which raised portions of the granular particles are formed is viewed in section in a direction of thickness, a recess-shaped portion constricted between each raised portion and the surface of the layer of the microscopic particles (hereafter called a “constriction”) is formed in each raised portion protruding from the layer of the microscopic particles. It is possible to enhance the adhesion of the outer side electrode and protection layer owing to an anchor effect produced by the outer side electrode and protection layer being caught on the constrictions.

### RELATED ART DOCUMENTS

### Patent Documents

[Patent Document 1] JP-A-11-230930
[Patent Document 2] JP-A-2002-323474

### SUMMARY OF THE INVENTION

### Problems to be Solved by the Invention

However, the particle size of the granular particles is prescribed in Patent Documents 1 and 2, but a place in which are included many granular particles of a particle diameter close to a lower limit may be formed due to variation in particle size. As the granular particles are buried in the layer of the microscopic particles in this kind of place, no constriction is formed in the raised portions, as a result of which the anchor effect decreases, and there is a danger that the adhesion of the outer side electrode and protection layer decreases.

Also, in a condition in which raised portions formed with constrictions and raised portions formed with no constriction are mixed, it is possible to secure the adhesion of the outer side electrode and protection layer when the number of raised portions per unit area is large, but it may happen that adjacent raised portions come into contact with each other, and that a cavity or hollow occurs between the raised portions. When water vapor intrudes into the cavity or hollow, and a thermal shock due to an expansion of the water vapor is received, there is a danger that a crack occurs in the solid electrolyte body. A distance between raised portions is prescribed in Patent Document 1, but it is not possible to completely eliminate a portion in which adjacent raised portions are in contact with each other in order to secure adhesion, and a further improvement in heat resistance in wet conditions is demanded.

The invention, having been contrived in order to solve the problems, has an object of providing a gas sensor element and gas sensor such that it is possible to secure the adhesion of the outer side electrode and protection layer, and to improve heat resistance in wet conditions.

### Means for Solving the Problems

According to a first aspect, there is provided a gas sensor element characterized by including: a bottomed cylindrical solid electrolyte body closed at the leading end; an inner side electrode and outer side electrode provided respectively on the inner surface and outer surface of the solid electrolyte body; a protection layer which covers and protects the outer side electrode; and an adhesion layer, forming a surface layer of the solid electrolyte body, including by a plurality of raised portions, and positioned in at least one portion of the solid electrolyte body outer surface corresponding to the protection layer, the gas sensor element detecting a specified gas component in gas to be measured, wherein the adhesion layer has the raised portions and a base portion from a surface of which the raised portions are protruded, when the number of raised portions formed per mm² on the surface of the base portion is taken to be N, 10≦N≦50, when the average of the heights of the raised portions protruding above the surface of the base portion in a direction perpendicular to the surface of the base portion is taken to be H, 55≦H≦75 [μm], and when the outer diameter of the raised portions is taken to be D, the number of raised portions with 45<D<90 [μm] is 70% or more of the total number.

Firstly, by prescribing the number N per mm² of raised portions configuring the adhesion layer as 10≦N≦50, it is possible to secure the adhesion of the outer side electrode and protection layer formed on the adhesion layer, and thus thermal durability, and it is possible to enhance the heat resistance in wet conditions of the gas sensor element.

When the number N per mm² of raised portions configuring the adhesion layer is less than 10, the number per unit area of constricted portions (portions each constricted in a recess shape inward in a radial direction toward the vicinity of a boundary between each raised portion and the surface of the base portion in the vicinity of the root of each raised portion protruding from the base portion) producing an anchor effect is relatively small. That is, regions in which it is possible to achieve the anchor effect which maintains the outer side electrode and protection layer in a tightly attached condition relatively decrease in a leading end portion of the solid electrolyte body. When flaking-off or floating occurs due to it not being possible to secure the adhesion of the outer side electrode and protection layer, it is difficult to secure thermal durability.

Meanwhile, when the number N of raised portions per mm² is larger than 50, there is a danger that there occurs a region in which raised portions are closely spaced, rather than being disposed well spaced apart, on the base portion. When adjacent raised portions come into contact with each other due to being closely spaced, it may happen that a cavity or hollow occurs between the raised portions. When water droplets intrude into this kind of cavity or hollow, there is a danger that a crack occurs in the solid electrolyte body due to a thermal shock caused by an expansion of water vapor in a thermal cycle, and it may happen that heat resistance in wet conditions decreases.

Also, by a cavity or hollow being produced between the raised portions, it may happen that a difference in density between a dense portion and nondense portion becomes greater in the protection layer formed on the adhesion layer. As the protection layer is formed by thermal spraying, when there is a cavity or hollow, a portion in which there is the cavity or hollow is liable to be formed to be nondense. When the difference in density of the protection layer becomes greater, there is a danger that variation occurs in sensor responsiveness.

Next, by prescribing the average (an average height H) of the heights, protruding above the surface of the based portion, of the raised portions configuring the adhesion layer as 55≦H≦75 [μm], it is possible to secure the adhesion of the outer side electrode and protection layer, and thus thermal durability, and to secure sensor responsiveness.

When the average height H of the raised portions is less than 55 μm, granular particles small in particle diameter, of the granular particles which are the source of the raised portions, increase as a whole. The granular particles small in particle diameter are such that the recesses of the constricted portions tend to become shallower, as compared with those of granular particles large in particle diameter, when the raised portions are formed. Then, it is difficult to achieve the anchor effect which maintains the outer side electrode and protection layer in the tightly attached condition, it is not possible to secure the adhesion of the outer side electrode and protection layer, and it is difficult to secure thermal durability.

Meanwhile, when the average height H of the raised portions is more than 75 μm, the difference in density between the dense portion and nondense portion becomes greater in the protection layer formed on the adhesion layer. As the protection layer is formed by thermal spraying, the protection layer is liable to be formed to be nondense on a root side (a side close to the base portion) of the raised portions having the constricted portions. As the greater the height of the raised portions, the deeper the recesses of the constricted portions, the protection layer formed on the root side of the raised portions is liable to become more nondense. When the difference in density of the protection layer becomes greater, there is a danger that variation occurs in sensor responsiveness.

Also, the average height H of the raised portions is not included in a range of 55 μm or more to 75 or less, in other words, it means that the heights of the raised portions greatly widely. Herein, when raised portions tall in height and raised portions short in height are mixed, when the outer side electrode is formed in a plating bath, a plated layer is formed to be thicker on the raised portions short in height after the plated layer has been formed all over until being formed on the raised portions tall in height. Because of this, it may happen that, the more widely the heights of the raised portions greatly, the larger the amount of material of the outer side electrode used.

Next, by prescribing the number of raised portions, configuring the adhesion layer, with an outer diameter D of 45<D<90 [μm] as 70% or more of the total number, it is possible to secure the adhesion of the outer side electrode and protection layer, and thus thermal durability, to secure sensor responsiveness, and to enhance heat resistance in wet conditions.

When raised portions with an outer diameter D of 45 to 90 μm are less than 70% of the total number, the outer diameters D of the raised portions greatly widely. The outer diameter D of the raised portions corresponds to the particle diameter of the granular particles which are the source of the raised portions. When the granular particles are biased toward a small particle diameter side due to a comparative increase of granular particles with a particle diameter of 45 μm or less, the recesses of the constricted portions become shallower when the raised portions are formed, it is difficult to achieve the anchor effect, it is not possible to secure the adhesion of the outer side electrode and protection layer, and it is difficult to secure thermal durability, as heretofore described. Meanwhile, when the granular particles are biased toward a large particle diameter side due to a comparative increase of granular particles with a particle diameter of 90 μm or more, the difference in density between the dense portion and nondense portion in the protection layer formed on the adhesion layer becomes greater, and there is a danger that variation occurs in sensor responsiveness, as heretofore described.

Also, when the sizes of the granular particles greatly widely when the adhesion layer is formed, there is a danger that there occur many portions in which granular particles overlap with each other. When the adhesion layer is formed in this condition, there is a danger that there occur many portions in which raised portions takes on a condition in which they are in contact with each other. When a cavity or hollow occurs between adjacent raised portions, as heretofore described, it may happen that the heat resistance in wet conditions of the gas sensor element decreases.

According to a second aspect, there is provided a gas sensor including: the gas sensor element according to the first aspect; a metal shell which holds the gas sensor element by enclosing a radial periphery of the gas sensor element; a metal pipe, whose leading end side is fixed to the metal shell, enclosing a rear end side radial periphery of the gas sensor element; and a pair of lead wires, connected one each to the pair of electrodes inside the metal pipe, which extract an output of the gas sensor element to the exterior.

By including the gas sensor element according to the first aspect, it is possible for the gas sensor to secure the adhesion of the outer side electrode and protection layer, and thus thermal durability, to secure sensor responsiveness, and to enhance heat resistance in wet conditions.

### BRIEF DESCRIPTION OF THE DRAWINGS

FIG. 1 is a sectional view of a gas sensor.

FIG. 2 is a sectional view of the vicinity of the leading end of a leading end portion of a sensor element.

FIG. 3 is an enlarged sectional view of the vicinity of a surface of the leading end portion 64 of the sensor element.

FIG. 4 is a diagram schematically showing a process of coating a mother body with paste using an overflow coating device.

FIG. 5 is a diagram showing a condition before firing of an adhesion layer formed in the vicinity of a surface of a mother body.

FIG. 6 is a diagram showing a condition after the firing of the adhesion layer formed in the vicinity of the surface of the mother body.

FIG. 7 is a diagram for illustrating a method of carrying out a heat resistance in wet conditions evaluation test.

### MODES FOR CARRYING OUT THE INVENTION

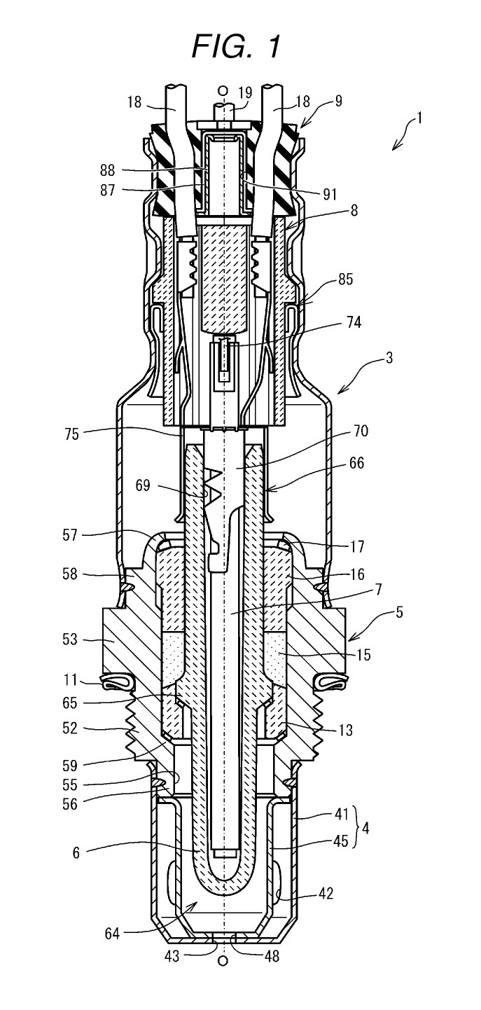

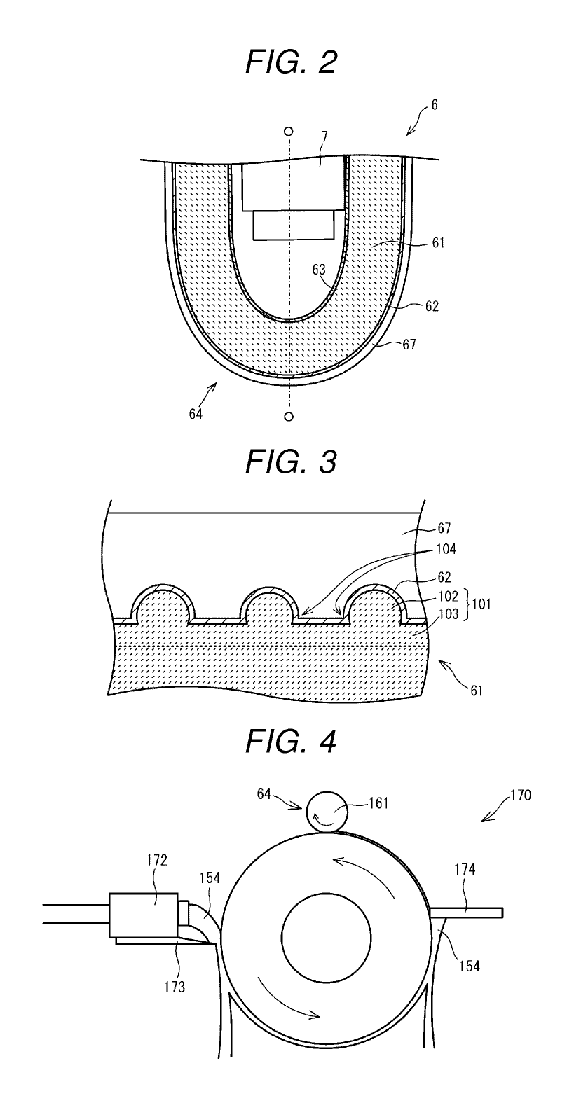

Hereafter, a description will be given, referring to the drawings, of one embodiment of a gas sensor element and gas sensor in which the invention is embodied. Firstly, referring to FIGS. 1 and 2, a description will be given, as one example, of a structure of a gas sensor 1 including a sensor element 6. The gas sensor 1 shown in FIG. 1 is used by being mounted in an exhaust pipe (not shown) for exhaust gas discharged from an internal-combustion engine of an automobile or the like. Hereafter, a description will be given with a side toward the leading end of the sensor element 6 inserted into the exhaust pipe (a closed side, the lower side in the drawing) as a leading end side, and a side toward a direction opposite thereto (the upper side in the drawing) as a rear end side, in an axis O direction of the gas sensor 1.

The gas sensor 1 shown in FIG. 1 is a sensor which detects whether or not there is oxygen in exhaust gas flowing in the exhaust pipe. The gas sensor 1 has a structure wherein the elongated cylindrical sensor element 6 closed at the leading end is enclosed and supported by a metal shell 5. The sensor element 6 shown in FIGS. 1 and 2 is configured with a zirconia-based solid electrolyte body 61 formed in a bottomed cylindrical shape extending in the axis O direction as a base body.

A flange-shaped flange portion 65 protruding outward in a radial direction is provided in a position on the solid electrolyte body 61 in approximately the center thereof in the axis O direction. A leading end portion 64 closer to the leading end side than the flange portion 65 is gradually reduced in diameter toward the leading end, and the leading end part is spherically closed. A porous sensing electrode 62 formed from Pt or Pt alloy is formed on the outer surface of the leading end portion 64 so as to cover substantially the whole of the outer surface. Also, a porous reference electrode 63 formed from Pt or Pt alloy is likewise formed on the inner surface of a cylindrical bore 69 of the solid electrolyte body 61 so as to cover substantially the whole of the inner surface. That is, the sensing electrode 62 and reference electrode 63 are opposite each other across the solid electrolyte body 61 in the leading end portion 64. This portion functions as a sensing portion which carries out a detection of oxygen concentration in the sensor element 6. When the gas sensor 1 is mounted in the exhaust pipe (not shown) of an automobile, the leading end portion 64 is exposed to exhaust gas flowing in the exhaust pipe. Therefore, the sensing electrode 62 is covered with a porous spinel protection layer 67, and protected from being poisoned by the exhaust gas. The sensing electrode 62 corresponds to an “outer side electrode” in the invention, and the reference electrode 63 corresponds to an “inner side electrode” in the invention.

As shown in FIG. 1, the sensing electrode 62 (refer to FIG. 2) of the sensor element 6 is connected to a lead wire 18, which carries out an electrical connection to an unshown external circuit (for example, an electronic control unit (ECU) of an automobile), via a connection terminal 75 making an outside fit with a rear end portion 66 of the sensor element 6. In the same way, the reference electrode 63 of the sensor element 6 is connected to another lead wire 18 via a connection terminal 70 inserted into the cylindrical bore 69 of the sensor element 6. Also, a rod-shaped heater 7 for heating and activating the solid electrolyte body 61 is inserted in the cylindrical bore 69 of the sensor element 6. The heater 7 is connected to a pair of lead wires 19 (only one lead wire 19 is shown in FIG. 1), which carry out an electrical connection to an external circuit, via a pair of electrode terminals 74 joined to an electrode exposed at the rear end of the heater 7 in order to carry current to a heater element (not shown) provided inside the heater 7.

The sensor element 6 is held in a cylindrical metal shell 5 which is a fitting for mounting the gas sensor 1 in the exhaust pipe (not shown). Specifically, the metal shell 5 supports a support member 13 formed from alumina, a filling member 15 formed from talc powder, and a sleeve 16 made from alumina, via a packing 17, between a shoulder portion 59 provided on the leading end side in a cylindrical hole 55 and a crimping portion 57 provided at the rear end. Further, the sensor element 6 is held in the cylindrical hole 55 by the flange portion 65 of the sensor element 6 being sandwiched between the support member 13 and filling member 15, and the inside of the cylindrical hole 55 is maintained airtight by the filling member 15.

The metal shell 5 has on the outer periphery an external thread portion 52 on which is formed a thread ridge for mounting the gas sensor 1 in the exhaust pipe. A leading end mounting portion 56 on which is mounted a protector 4, to be described hereafter, is formed on the leading end side of the external thread portion 52. A tool engagement portion 53 with which is engaged a tool used when the gas sensor 1 is mounted in the exhaust pipe is provided on the rear end side of the external thread portion 52. An annular gasket 11 for preventing outgassing through an exhaust pipe mounting portion is inserted between the tool engagement portion 53 and external thread portion 52. A rear end mounting portion 58 on which is mounted a metal pipe 3, to be described hereafter, is formed on the rear end side of the tool engagement portion 53. The crimping portion 57 is provided on the rear end side of the rear end mounting portion 58.

The leading end side of the leading end portion 64 of the sensor element 6 is protruded from the leading end mounting portion 56 of the metal shell 5, and covered with the protector 4 welded to the leading end mounting portion 56. The protector 4 protects the leading end portion 64 of the sensor element 6 protruded into the exhaust pipe from being hit by water droplets, foreign substances, or the like, contained in exhaust gas. The protector 4 has a double structure formed of an outside protector 41 and inside protector 45. Introduction ports 42 through which exhaust gas is introduced into the inside and led to the leading end portion 64 (sensing portion) of the sensor element 6 are opened one each in the outer peripheral surfaces of the outside protector 41 and inside protector 45 (the gas introduction port of the inside protector 45 is not shown). Exhaust ports 43 and 48 for discharging water droplets and exhaust gas intruding into the inside are opened in the bottom surfaces of the respective outside protector 41 and inside protector 45.

The rear end portion 66 of the sensor element 6 is protruded from the rear end (crimping portion 57) of the metal shell 5, and covered with the metal pipe 3 welded to the rear end mounting portion 58. The metal pipe 3 is such that stainless steel such as SUS304 is formed in a cylindrical shape extending in the axis O direction, and furthermore, a portion thereof closer to the leading end side than substantially the center (on the lower side in FIG. 1) is formed to have a diameter larger than that of a portion on the rear end side. The rear end portion 66 of the sensor element 6, a separator 8, a grommet 9, and the like, are disposed in the metal pipe 3.

The cylindrical separator 8 formed from insulating ceramic is disposed in a portion closer to the rear end side in the axis O direction than the rear end portion 66 of the sensor element 6. The connection terminals 70 and 75 of the sensor element 6 and the electrode terminals 74 of the heater 7 are independently housed inside the separator 8 so as not to be in contact with each other. Also, air can communicate between the leading end side and rear end side of the separator 8 via a space between the connection terminals 70 and 75 and electrode terminal 74 and the inner peripheral surface. By an outer peripheral portion of the metal pipe 3 in which the separator 8 is disposed being crimped, the separator 8 is held in the metal pipe 3 via a holding fitting 85.

The grommet 9 formed from fluorine series rubber is disposed on the rear end side of the separator 8. The grommet 9 is fitted in the rear end side opening of the metal pipe 3, and held in the metal pipe 3 by an outer periphery of the metal pipe 3 in the vicinity of the opening being crimped. A communication hole 91 for introducing air into the metal pipe 3 is formed in the grommet 9. A thin-film filter member 87 formed from fluorine resin such as, for example, PTFE (polytetrafluoroethylene) and a brace 88 thereof are inserted in the communication hole 91, thus preventing intrusion of water droplets or the like. Also, the lead wires 18 connected to the connection terminals 70 and 75 in the separator 8 and the lead wires 19 connected to the electrode terminals 74 are led out to the exterior via the grommet 9.

The sensor element 6 used in this kind of gas sensor 1 is such that the outer surface of the leading end portion 64 of the base body formed of the solid electrolyte body 61 has a rugged shape for securing the adhesion of the sensing electrode 62 and protection layer 67. As shown in FIG. 3, the solid electrolyte body 61 includes on the outer surface of the leading end portion 64 (refer to FIG. 2) an adhesion layer 101 forming a surface layer of the solid electrolyte body 61. The adhesion layer 101 has a plurality of raised portions 102 protruding from a surface and a base portion 103 from which the raised portions 102 are protruded. The raised portions 102 form a hemispherical shape. A region constricted in a recess shape, inward in a radial direction, toward the vicinity of the boundary between each raised portion 102 and the surface of the base portion 103 (hereafter referred to as a “constricted portion” 104) is formed in the vicinity of the root at which each raised portion 102 protrudes from the base portion 103.

As heretofore described, the sensing electrode 62 is formed by the surface of the adhesion layer 101 configuring the surface layer of the solid electrolyte body 61, that is, the surfaces of the raised portions 102 and base portion 103, being covered with Pt or Pt alloy. The sensing electrode 62, by slotting into the recesses in the constricted portions 104, covers the surface of the adhesion layer 101, including the boundaries between the raised portions 102 and base portion 103. Because of this, the sensing electrode 62 produces a drag (a so-called anchor effect) by being caught on the constricted portions 104 even when receiving stress in a direction away from the surface of the base portion 103. The solid electrolyte body 61, by having on the surface layer the raised portions 102 protruding from the base portion 103 as the adhesion layer 101 in this way, can secure the adhesion of itself to the sensing electrode 62.

Also, the protection layer 67 is provided around the leading end portion 64 of the solid electrolyte body 61 so as to cover the sensing electrode 62. The thickness of the sensing electrode 62 is, for example, 1 μm, and as the recesses of the constricted portions 104 are likely to be formed to be deeper than the thickness of the sensing electrode 62, it is often the case that the recesses still remain in the constricted portions 104 even after the sensing electrode 62 is formed, as will hereafter be described in detail. Therefore, the protection layer 67, by slotting into the recesses of the constricted portions 104 in the same way as the sensing electrode 62, covers the surface of the adhesion layer 101 together with the sensing electrode 62. Consequently, the anchor effect produced by the constricted portions 104 acts effectively on the protection layer 67, and the solid electrolyte body 61 can also secure the adhesion of itself to the protection layer 67.

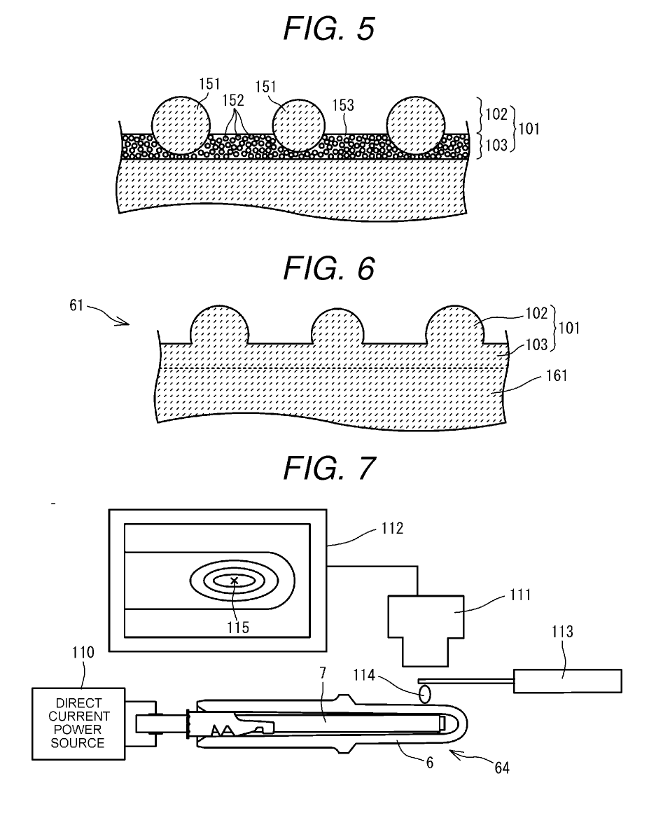

As will be described hereafter, the adhesion layer 101 is formed by coating the outer surface of the unbaked solid electrolyte body 61 with paste including two kinds of particle (granular particles 151 and microscopic particles 152 (refer to FIG. 5)) and co-firing the paste and solid electrolyte body 61. In the embodiment, the following prescriptions (1) to (3) are made in order to secure the adhesion of the sensing electrode 62 and protection layer 67 formed on the adhesion layer 101, and to suppress a decrease in heat resistance in wet conditions caused by a contact between adjacent raised portions 102 in the adhesion layer 101.

(1) It is prescribed that when the number of raised portions 102 formed per mm² on the surface of the base portion 103 of the adhesion layer 101 is taken to be N, 10≦N≦50.
(2) It is prescribed that when an average height of the raised portions 102 protruding above the base portion 103 in a direction perpendicular to the surface of the base portion 103 (which is, in other words, a direction of thickness of the bottomed cylindrical solid electrolyte body 61, and is hereafter called a “direction of protrusion” for sake of simplicity) is taken to be H [μm], 55≦H≦75.
(3) It is prescribed that when the outer diameter of the raised portions 102 is taken to be D [μm], the number of raised portions 102 with 45<D<90 is 70% or more of the total number of raised portions 102. The outer diameter D of the raised portions 102 is a maximum outer diameter of the raised portions 102 in a direction perpendicular to the direction of protrusion of the raised portions 102.

With regard to the prescription (1), according to Working Example 1, to be described hereafter, when the number N of raised portions 102 is less than 10, the number per unit area of constricted portions 104 producing the anchor effect is relatively small. That is, regions in which it is possible to achieve the anchor effect which maintains the sensing electrode 62 and protection layer 67 in a tightly attached condition relatively decrease in the leading end portion 64 of the solid electrolyte body 61. When flaking-off or floating occurs due to it not being possible to secure the adhesion of the sensing electrode 62 and protection layer 67, it is difficult to secure thermal durability.

Meanwhile, when the number N of raised portions 102 is more than 50, there is a danger that a region in which raised portions 102 are closely spaced, rather than being disposed well spaced apart, occurs on the base portion 103. When adjacent raised portions 102 come into contact with each other due to being closely spaced, it may happen that a cavity or hollow occurs between the raised portions 102. When water droplets intrude into this kind of cavity or hollow, there is a danger that a crack occurs in the solid electrolyte body 61 due to a thermal shock caused by an expansion of water vapor in a thermal cycle, and it may happen that heat resistance in wet conditions decreases.

Also, by a cavity or hollow being produced between the raised portions 102, it may happen that a difference in density between a dense portion and nondense portion becomes greater in the protection layer 67 formed on the adhesion layer 101. As the protection layer 67 is formed by thermal spraying, as will be described hereafter, when there is a cavity or hollow, a portion in which there is the cavity or hollow is liable to be formed to be nondense. When the difference in density of the protection layer 67 becomes greater, there is a danger that variation occurs in sensor responsiveness.

With regard to the prescription (2), according to Working Example 2, to be described hereafter, when the average height H of the raised portions 102 is less than 55 μm, granular particles small in particle diameter, of the granular particles 151 (refer to FIG. 5) which are the source of the raised portions 102, increase as a whole. The granular particles 151 small in particle diameter are such that the recesses of the constricted portions tend to become shallower, as compared with those of granular particles 151 large in particle diameter, when the raised portions 102 are formed. Then, it is difficult to achieve the anchor effect which maintains the sensing electrode 62 and protection layer 67 in the tightly attached condition, it is not possible to secure the adhesion of the sensing electrode 62 and protection layer 67, and it is difficult to secure thermal durability.

Meanwhile, when the average height H of the raised portions 102 is more than 75 μm, the difference in density between the dense portion and nondense portion becomes greater in the protection layer 67 formed on the adhesion layer 101. As the protection layer 67 is formed by thermal spraying, the protection layer 67 is liable to be formed to be nondense on a root side (a side close to the base portion 103) of the raised portions 102 having the constricted portions 104. As the greater the height of the raised portions 102, the deeper the recesses of the constricted portions 104, the protection layer 67 formed on the root side of the raised portions 102 is liable to become more nondense. When the difference in density of the protection layer 67 becomes greater, there is a danger that variation occurs in sensor responsiveness.

Also, the average height H of the raised portions 102 is not included in a range of 55 μm or more to 75 or less, in other words, it means that the heights of the raised portions 102 greatly widely. Herein, the sensing electrode 62 formed from Pt or Pt alloy is formed in a plating bath. When raised portions 102 tall in height and raised portions 102 short in height are mixed, a plated layer is formed to be thicker on the raised portions 102 short in height after the plated layer has been formed all over until being formed on the raised portions 102 tall in height. Because of this, it may happen that, the more widely the heights of the raised portions 102 greatly, the larger the amount of Pt used.

With regard to the prescription (3), according to Working Examples 3 and 4, to be described hereafter, when raised portions 102 with an outer diameter D of 45 to 90 μm are less than 70% of the total number, the outer diameters D of the raised portions 102 greatly widely. The outer diameter D of the raised portions 102 corresponds to the particle diameter of the granular particles 151 (refer to FIG. 5) which are the source of the raised portions 102, as will be described hereafter. When the granular particles 151 are biased toward a small particle diameter side due to a comparative increase of granular particles 151 with a particle diameter of 45 μm or less, the recesses of the constricted portions 104 become shallower when the raised portions 102 are formed, it is difficult to achieve the anchor effect, it is not possible to secure the adhesion of the sensing electrode 62 and protection layer 67, and it is difficult to secure thermal durability, as heretofore described. Meanwhile, when the granular particles 151 are biased toward a large particle diameter side due to a comparative increase of granular particles 151 with a particle diameter of 90 μm or more, the difference in density between the dense portion and nondense portion in the protection layer 67 formed on the adhesion layer 101 becomes greater, and there is a danger that variation occurs in sensor responsiveness, as heretofore described.

Also, when the sizes of the granular particles 151 greatly widely when the adhesion layer 101 is formed, there is a danger that there occur many portions in which granular particles 151 overlap with each other. When the adhesion layer 101 is formed in this condition, there is a danger that there occur many portions in which raised portions 102 takes on a condition in which they are in contact with each other. When a cavity or hollow occurs between adjacent raised portions 102, as heretofore described, it may happen that the heat resistance in wet conditions of the sensor element 6 decreases.

Next, a description will be given of a method of manufacturing the gas sensor 1 including the sensor element 6 with the heretofore described configuration. Firstly, the sensor element 6 is manufactured in the following way.

Examples of the material of the solid electrolyte body 61 include materials based on any kind of ceramic, for example, stabilized or partially stabilized zirconia, and containing Al₂O₃, SiO₂, or Fe₂O₃, as necessary. As the manufacturing method, normally, after divalent to trivalent metal oxide such as Y₂O₃. CaO, or MgO is mixed with ZrO₂ in a desired ratio, and the mixture is milled, the milled mixture is preliminarily fired in an electric furnace and finely milled again, thereby obtaining stabilized or partially stabilized zirconia raw powder. Next, the raw powder is formed in a substantially cylindrical shape, for example, into a cylindrical body closed at one leading end by a pressure forming method, such as a rubber pressing method, or a laminating method, such as a thick film processing, and it is thereby possible to obtain the solid electrolyte body 61.

Particularly, a mixture wherein 6 mol % of yttrium oxide is added to zirconium oxide, after being wet milled for 70 hours, is dried, and screened through a 20 mesh sieve. This is calcined in an electric furnace at 1300° C. for one hour, and screened through a 20 mesh sieve. Further, a dry ball milling is carried out for 50 hours, thus obtaining finely milled raw powder in which is contained 90% powder of a size of 2.5 μm or less. Slurry obtained by adding gum arabic as organic binder to the raw powder is dried by a spray dryer, thus obtaining particles with an average particle diameter of in the order of 60 μm. The moisture content of the particles is adjusted to 1%, and 50 Pa rubber press forming is carried out, thus obtaining a mother body 161 (refer to FIG. 4) which is the source of the bottomed cylindrical solid electrolyte body 61 closed on one side. The mother body 161 is such that the average outer diameter of the leading end portion 64 (a portion covered with the protection layer 67, to be described hereafter) is 6.5 mm, and the outer surface area is approximately 5.7 cm².

Also, it is preferable that the granular particles 151 and microscopic particles 152 are formed from substantially the same kind of material as that of the mother body 161. The material of the granular particles 151 and microscopic particles 152 is not necessarily exactly the same as that of the mother body 161, but the materials of the particles 151 and 152 and mother body 161 are not preferable unless the properties thereof are basically similar to each other because it is difficult for the granular particles 151 and microscopic particles 152 to be caused to stably and tightly anchor integrally to the mother body 161 by a subsequent firing process.

Particularly, particles obtained by being dried by a spray dryer in the same way as heretofore described are calcined at a temperature 1200 to 1300° C. for one hour. The calcined particles are sieved and classified, thus obtaining granular particles 151 (refer to FIG. 5), 70% or more of which have a particle diameter of 45 to 90 μm (particles with a particle diameter of over 90 μm are 5% or less, and particles with a particle diameter of less than 45 μm are 25% or less).

When more than 25% granular particles with a particle diameter (that is, the outer diameter D of the raised portions 102 after the formation of the adhesion layer 101) of less than 45 μm are contained, it is difficult for a large number of raised portions 102 with good heat resistance to be formed on the surface of the mother body 161 in the process of forming the adhesion layer 101. This case is not preferable because there is a tendency to take on a kind of condition in which a porous layer is formed on the surface of the mother body 161. Also, when more than 5% granular particles with a particle diameter of over 90 μm are contained, it is difficult for a sufficient number of raised portions 102 to be formed on the surface of the mother body 161 in the process of forming the adhesion layer 101. In this case, it is not possible to secure the adhesion of the sensing electrode 62 and protection layer 67 formed on the adhesion layer 101, and there is a danger that it is not possible to secure sufficient thermal durability. A granulation method for obtaining this kind of granular particle 151 is not particularly limited, but when the granular particles 151 are manufactured by the heretofore mentioned spray dryer, the particle shape thereof is easily stabilized. Moreover, the granular particles 151 are easily formed as more refined particles, and the strength of cohesion of the mother body 161 and granular particles 151 becomes higher, meaning that this method is preferable.

In the same way, microscopic particles 152 (refer to FIG. 5), most of which are of a particle diameter of 10 μm or less, preferably, 80% or more of which are of a particle diameter of 2.5 μm or less, are obtained by classification. The microscopic particles 152 are used as a sintering additive for aiding the cohesion of the mother body 161 and granular particles 151. Therefore, when the particle diameter is large (when 20% or more microscopic particles 151 with a particle diameter of more than 2.5 μm are contained), it is not possible to sufficiently serve as the sintering additive.

The granular particles 151 and microscopic particles 152 obtained by being classified in this way are added to a mixed solvent 153 (refer to FIG. 5) wherein water and water-soluble binder NH₄-CMC are mixed, in such a way that the mixing weight ratio of the granular particles to the microscopic particles is 30:70 to 20:80, thus preparing paste 154 (refer to FIG. 4) with a viscosity in a range of 600 to 1700 CPS. Herein, the mixed solvent 153 is preferably one wherein water and organic binder are mixed so that the mixing ratio is 100:1 to 40:1. Examples of organic binder include Na-CMC (cellulose sodium glycolate), NH₄-CMC (cellulose ammonium glycolate), and PVA (polyvinyl alcohol). The mixing ratio of water and organic binder may have a big effect on the viscosity of the paste 154. For example, when NH₄-CMC is used, the viscosity decreases when the proportion of water exceeds 100:1, and the granular particles 151 in the paste 154 precipitate quickly, meaning that there is a danger that it is difficult for the raised portions 102 to be uniformly formed all over the surface of the mother body 161. The viscosity increases when the proportion of water becomes less than 40:1, and it may happen that the raised portions 102 are liable to be stacked one on another on the mother body 161. Then, there is a danger that the granular particles 151 and microscopic particles 152 flake off from the mother body 161 due to the cohesive strength of a binder layer after moisture dries out.

When the percentage of the granular particles 151 with respect to the microscopic particles 152 is higher than 30%, portions in which the granular particles 151 overlap with each other on the surface of the mother body 161 increase. Then, cavities or hollows formed between adjacent granular particles 151 increase, and it may happen that the heat resistance in wet conditions of the solid electrolyte body 61 formed after the firing decreases, as heretofore described. Also, the densities of the protection layer 67 formed covering the raised portions 102 by thermal spraying tend to greatly more widely, which is not preferable. Meanwhile, when the percentage of the granular particles 151 with respect to the microscopic particles 152 is lower than 20%, it is difficult to cause a sufficient number of raised portions 102 to be formed on the surface of the mother body 161. Then, it is not possible to secure the adhesion of the sensing electrode 62 and protection layer 67 formed on the adhesion layer 101, and there is a danger that it is not possible to secure sufficient thermal durability.

Of the outer surface of the unbaked mother body 161, an outer surface of the leading end portion 64 covered with the protection layer 67, to be described hereafter, is coated with the paste 154 prepared in the way heretofore described, using an overflow coating device 170. As shown in FIG. 4, the overflow coating device 170 includes a rotating drum (a drum diameter of 90 mm), a paste supply member 172, a supply plate 173, a scraping plate 174, and a mother body rotation support member (not shown). The rotating drum 171 provides (coats) the outer surface of the unbaked mother body 161 with the paste 154. The paste supply member 172 supplies the paste 154 to the outer peripheral surface of the rotating drum 171 from an obliquely upward position on the rotating drum 171. The supply plate 173, as well as adjusting the amount of paste 154 supplied by the paste supply member 172, coats the outer peripheral surface of the rotating drum 171 with the paste 154 so that the paste 154 spreads over the outer peripheral surface of the rotating drum 171. The scraping plate 174 levels off the paste 154 so that the thickness of the paste 154 on the outer peripheral surface of the rotating drum 171 is constant (for example, 250 μm). The mother body rotation support member (not shown) supports the unbaked mother body 161 so that the mother body 161 can rotate around its axis, and holds the mother body 161 in a condition in which the outer surface of the leading end portion 64 of the mother body 161 is in contact with the paste 154 on the outer peripheral surface of the rotating drum 171. The leading end portion 64 of the mother body 161 is coated with the paste 154 by the paste 154 provided to the rotating drum 171 crawling up.

It is preferable that the weight of adhesion of the paste 154 to the mother body 161 is 3.0 to 12.0 mg/cm². When the adhesion weight is less than 3.0 mg/cm², it is difficult to form a sufficient number of raised portions 102 on the surface of the mother body 161, and there is a danger that it is not possible to sufficiently secure thermal durability. Meanwhile, when the adhesion weight exceeds 12.0 mg/cm², there is a danger that there occur many portions in which granular particles 151 overlap with each other, and it may happen that heat resistance in wet conditions decreases.

After the mother body 161 is coated with the paste 154, the mother body 161 coated with the paste 154 is fired at 1600° C. for one hour under an oxidative atmosphere. As shown in FIG. 6, the solid electrolyte body 61 formed by firing the mother body 161 (refer to FIG. 5) is such that the granular particles 151 and microscopic particles 152 (refer to FIG. 5) configuring the adhesion layer 101 forming the surface layer are integrated with the mother body 161.

After the firing, the sensing electrode 62 and reference electrode 63 are deposited on the inner side and outer side of the solid electrolyte body 61. Specific examples of the sensing electrode 62 and reference electrode 63 include platinum, ruthenium, rhodium, palladium, and an alloy of these. Examples of a method of depositing the electrodes include a vacuum vapor deposition method, a chemical vapor deposition method, an electroless plating method, an electroplating method, and a method of, after coating a metal salt to be decomposed, heating the metal salt, thus electrodepositing the metal. Furthermore, the spinel protection layer 67 covering the sensing electrode 62 is formed by a well-known plasma spraying method. By so doing, the sensor element 6 shown in FIG. 2 is obtained.

Next, a description will be given of an assembling of the gas sensor 1. The metal shell 5 is fabricated by performing a forge processing on a pipe-like steel material formed from stainless steel such as SUS430, and next, after performing a cutting work, thus forming the shapes of the tool engagement portion 53, rear end mounting portion 58, external thread portion 52, cylindrical hole 55, and the like, performing a thread rolling on the external thread portion 52, thus forming a thread ridge thereon. The protector 4 fabricated in a separate process is joined to the metal shell 5 by welding, and the sensor element 6 is crimped and held in the cylindrical hole 55 of the metal shell 5, thereby fabricating a leading end side assembly intermediate body of the gas sensor 1.

Meanwhile, the cores of the lead wires 18 are crimped and joined to the respective connection terminals 70 and 75 fabricated from a conductive plate material. Also, the cores of the lead wires 19 are crimped and joined to the two respective electrode terminals 74 of the heater 7. The connection terminals 70 and 75 and heater 7 are housed in the separator 8. The lead wires 18 and 19 are inserted through the grommet 9 assembled with the filter member 87 and the like, and the grommet 9, as well as the separator 8, is disposed in a predetermined position in the metal pipe 3. The outer periphery of the metal pipe 3 is crimped to hold the separator 8 and grommet 9, thereby fabricating a rear end side assembly intermediate body of the gas sensor 1.

The leading end side assembly intermediate body and rear end side assembly intermediate body are combined with each other, and the periphery of a leading end portion of the metal pipe 3 engaged with the rear end mounting portion 58 of the metal shell 5 is crimped. Furthermore, laser welding is performed on the periphery of the leading end portion of the metal pipe 3, thus integrating the two assembly intermediate bodies. The four lead wires 18 and 19 are bundled together and covered with a covering (not shown), and the gas sensor 1 is completed.

As heretofore described, the gas sensor 1 of the embodiment is such that the adhesion layer 101 having a rugged shape is formed on the surface layer of the leading end portion 64 of the sensor element 6, thus securing the adhesion of the sensing electrode 62 and protection layer 67. More particularly, the adhesion layer 101 has the plurality of raised portions 102 protruding from the base portion 103, but the prescriptions (1) to (3) are made to form the raised portions 102. Specifically, in accordance with the prescriptions (1) and (3), by further reducing the number of raised portions 102 per mm² than heretofore known, thus reducing variation in the outer diameter D, it is possible to improve the heat resistance in wet conditions of the sensor element 6. The trade-off for this is that there is a danger that it is not possible to secure the adhesion of the sensing electrode 62 and protection layer 67, and thus thermal durability, but by adopting an arrangement such that it is possible to reliably obtain the anchor effect of the raised portions 102 in accordance with the prescription (2), it is possible to secure adhesion. Also, it is also possible to reduce the amount of Pt used.

### Working Example 1

Evaluation tests are carried out in order to confirm the efficacies of making the prescriptions (1) to (3) to form the outer surface of the solid electrolyte body 61 of the sensor element 6 in a rugged shape. Firstly, a test confirming heat resistance in wet conditions and the adhesion (thermal durability) of the protection layer 67 is carried out in order to confirm the efficacy of the prescription (1). In the heretofore described process of manufacturing the sensor element 6, pastes 154 with the mixing ratios of the granular particles 151 and microscopic particles 152 set to various ratios differing from one another are prepared, and the mother bodies 151 are coated with the pastes 154 and fired, thus obtaining samples of the solid electrolyte body 61.

Next, an area of 1 mm width by 14 mm length in the axis O direction, of the surface of the leading end portion 64 of each sample, is photographed using an ultra-depth microscope (a laser microscope), and the condition of the surface is observed. The ultra-depth microscope is set to have a lens magnification of ×200, a pitch of 5 μm, and an optical zoom magnification of ×1. The number of raised portions 102 included in the area of 1 mm×14 mm is counted from the photographed image and, of samples of which the numbers N of raised portions 102 per mm² are 5, 10, 30, 50, and 70, a plurality of samples of each type are extracted and taken to be samples 1A to 1E in order.

Furthermore, with regard to each extracted sample 1A to 1E, a 100 μm×100 μm square region in the area of 1 mm×14 mm is displayed, and ten raised portion 102 fitted within the region are arbitrarily selected. That is, ten raised portions 102 which exist individually even by being marked off by the 100 μm×100 μm square region, rather than adjacent raised portions 102 being close to or in contact with each other, are arbitrarily selected. Further, an image of the selected ten raised portions 102 photographed by the ultra-depth microscope is three-dimensionally synthesized, and the heights of the individual raised portions 102 protruding above the base portion 103 are measured to calculate the average value (average height H).

When the mother body 161 is coated with the paste 154 in the heretofore described manufacturing process in order to form the adhesion layer 101, it does not happen that a half or more of the particle diameter (that is, the outer diameter D of the raised portions 102) of the granular particles 151 which are the source of the raised portions 102 is buried in the microscopic particles 152 which are the source of the base portion 103 and in the binder layer. However, the granular particles 151 may be disposed floating above the binder layer. In the embodiment, how to measure the height of each raised portion 102 is such that when the height of protrusion of a raised portion 102 is 75% or more of the outer diameter D of the raised portion 102, the raised portion 102 is determined not to be integrated with the base portion 103, and is excluded from an object of which the height of protrusion is measured.

Samples of which the average height H of the raised portions 102 is 60 μm are extracted and kept as the samples 1A to 1E, and samples of which the average height H of the raised portions 102 is not 60 μm are excluded from the samples. Further, the sensing electrode 62 and protection layer 67 is formed on each sample 1A to 1E, and each of the samples 1A to 1E is completed as the sensor element 6.

A test evaluating heat resistance in wet conditions is carried out on each of the samples 1A to 1E of which the numbers N of raised portions 102 are different. As shown in FIG. 7, one sample is taken out from among the prepared plurality of samples of each sample 1A to 1E, the heater 7 is inserted into the cylindrical bore 69 and connected for energization to a direct current power source 110, and the sensor element 6 is raised to a predetermined temperature (for example, 500° C.) The surface of the leading end portion 64 of the sensor element 6 is photographed by a thermo tracer (an infrared camera) 111, and the photographed image is displayed on a monitor 112 to observe the condition of the surface temperature. A 2 μl drop of water is put on a portion 115, whose surface temperature is a maximum temperature, using a microsyringe 113. When the temperature lowered by putting the drop of water is raised to the predetermined temperature, a 2 μl drop of water 114 is put again, and after this is repeated five times, it is confirmed by a red check whether or not a crack has occurred in the vicinity of the portion on which the drops of water have been put. If there is no crack, a temperature 25° C. higher than the predetermined temperature is set, another unevaluated sample is taken out from among the plurality of samples of each sample 1A to 1E in the way heretofore described, and after the drop of water 114 is put five times, it is confirmed whether or not there is a crack. In this way, the temperature of the heater is raised every 25° C., and a temperature when it is confirmed that a crack has occurred is specified for each sample 1A to 1E. Samples wherein a crack has occurred at 575° C. or less are evaluated as “Bad” because it is not possible to secure heat resistance in wet conditions. Samples wherein a crack has occurred at 600° C. are evaluated as “Triangle” because heat resistance in wet conditions is not sufficient. Samples wherein a crack has occurred at 625° C. or more are evaluated as “Good” because it is possible to obtain sufficient heat resistance in wet conditions.

Next, one unevaluated sample is taken out from among each sample 1A to 1E, and a test evaluating the adhesion (thermal durability) of the protection layer 67 is carried out. The leading end portion 64 of each sample 1A to 1E is heated to 1000° C. by a burner, a treatment of carrying out room temperature cooling for five minutes is taken to be one cycle, and the cycle is repeated. It is visually confirmed each time one cycle finishes whether or not flaking-off has occurred in the protection layer 67. The number of times the cycle is repeated until flaking-off occurs is specified for each sample 1A to 1E. Samples wherein flaking-off has occurred by the cycle being repeated 300 times or less are evaluated as “Bad” because it is not possible to secure adhesion. Samples wherein flaking-off has occurred by the cycle being repeated 301 to 499 times are evaluated as “Triangle” because adhesion is not sufficient. Samples wherein flaking-off has occurred by the cycle being repeated 500 times or more are evaluated as “Good” because it is possible to obtain sufficient adhesion. Results of the heat resistance in wet conditions and adhesion evaluation tests are shown in Table 1.

TABLE 1

| | | | Adhesion of |
|---|---|---|---|
| | Number N of | heat resistance | spinel |
| | raised portions | in wet | protection |
| Sample | per mm² | conditions | layer |
| 1A | 5 | Good | Bad |
| 1B | 10 | Good | Good |
| 1C | 30 | Good | Good |
| 1D | 50 | Good | Good |
| 1E | 70 | Bad | Good |

As shown in Table 1, with the samples 1A to 1D of which the numbers N of raised portions 102 per mm² are 5 to 50, as the raised portions 102 are disposed spaced apart, rather than being closely spaced, on the base portion 103, it is possible to secure sufficient heat resistance in wet conditions. However, with the samples 1E of which the number N of raised portions 102 per mm² are 70, as the raised portions 102 are closely spaced, cavities or hollows occur, and heat resistance in wet conditions decrease. Also, with the samples 1B to 1E of which the numbers N of raised portions 102 per mm² are 10 to 70, as it does not happen that flaking-off occurs in the protection layer 67 even by the thermal cycle being repeated 500 times or more, it can be confirmed that it is possible to secure sufficient adhesion (thermal durability), and thus possible to obtain the same degree of anchor effect as heretofore known. However, with the samples 1A of which the numbers N of raised portions 102 per mm² are five, as flaking-off has occurred in the protection layer 67 by the thermal cycle being repeated 300 or less times, it is not possible to secure adhesion, and thus not possible to obtain the same degree of anchor effect as heretofore known. It can be confirmed from these evaluation test results that it is possible to secure the adhesion of the protection layer 67 too while enhancing heat resistance in wet conditions by prescribing in such a way that the numbers N of raised portions 102 per mm² are 10 to 50.

### Working Example 2

Next, a test confirming the adhesion (thermal durability) of the protection layer 67 and sensor responsiveness is carried out in order to confirm the efficacy of the prescription (2). In the process of manufacturing the sensor element 6, pastes 154 with the mixing ratios of the granular particles 151 and microscopic particles 152 set to a predetermined ratio are prepared, and the mother bodies 161 are coated with the pastes 154 and fired, thus obtaining samples of the solid electrolyte body 61. In the surface of the leading end portion 64 of each sample, the number of raised portions 102 included in the area of 1 mm×14 mm is counted using the ultra-depth microscope in the same way as in Working Example 1, and samples of which the numbers N of raised portions 102 per mm² are 30 are extracted.

Furthermore, in the same way as in Working Example 1, the heights of the raised portions 102 of each extracted sample protruding above the base portion 103 are measured to calculate the average height H. In this working example, samples of which the average heights H of the raised portions 102 are 40 μm, 55 μm, 60 μm, 75 μm, and 105 μm have been able to be prepared as samples 2A to 2E in order. Further, the sensing electrode 62 and protection layer 67 are formed on each sample 2A to 2E which has been able to be prepared, and each sample 2A to 2E is completed as the sensor element 6.

Further, each sample 2A to 2E is completed as the gas sensor 1, and assembled to a bush installed in a chamber into which the atmosphere including propane is supplied. The gas sensor 1 is energized to acquire an output value (a λ value) of the sensor element 6, and propane is cyclically injected into the chamber so that the λ value varies between 0.9 and 1.1, thus causing the air-fuel ratio of the atmosphere to cyclically vary between rich and lean. Further, an elapsed time from propane being injected until the λ value changes accordingly is measured for each sample 2A to 2E. Samples wherein variation in the elapsed time is 21 ms or more are evaluated as “Bad” because sensor responsiveness is not good. Samples wherein variation in the elapsed time is 15 ms to 20 ms are evaluated as “Triangle” because sensor responsiveness is not desirable. Samples wherein variation in the elapsed time is 14 ms or less are evaluated as “Good” because sensor responsiveness is good.

Furthermore, with regard to each sample 2A to 2E, the sensor element 6 is removed from the assembled gas sensor 1, and a test evaluating the adhesion (thermal durability) of the protection layer 67, wherein heating by a burner and room temperature cooling which are the same as in Working Example 1 is repeated, is carried out. Results of the adhesion (thermal durability) and sensor responsiveness evaluation test are shown in Table 2.

TABLE 2

| | | Adhesion of | |
|---|---|---|---|
| | Average height H | spinel | |
| | of raised | protection | Sensor |
| Sample | portions | layer | responsiveness |
| 2A | 40 μm | Bad | Good |
| 2B | 55 μm | Good | Good |
| 2C | 60 μm | Good | Good |
| 2D | 75 μm | Good | Good |
| 2E | 105 μm | Good | Bad |

As shown in Table 2, with the samples 2B to 2E of which the average height H of the raised portions 102 is 55 μm to 105 μm, no flaking-off has occurred in the protection layer 67 even by the thermal cycle being repeated 500 times or more. With the samples 2B to 2E, it can be confirmed that it is possible to secure sufficient adhesion (thermal durability), and thus possible to obtain the same degree of anchor effect as heretofore known. However, with the samples 2A of which the average height H of the raised portions 102 is 40 μm, as flaking-off has occurred in the protection layer 67 by the thermal cycle being repeated 300 times or less, it is not possible to secure adhesion, and thus not possible to obtain the same degree of anchor effect as heretofore known. Also, with the samples 2A to 2D of which the average height H of the raised portions 102 is 40 μm to 75 μm, as it can be confirmed that the λ value changes in 14 ms or less after the air-fuel ratio changes, it is possible to secure sufficient sensor responsiveness. However, with the samples 2E of which the average height H of the raised portions 102 is 105 μm, as it takes 21 ms or more from the air-fuel ratio changing until the λ value changes, it is not possible to obtain a sufficient speed as sensor responsiveness. It can be confirmed from these evaluation test results that it is possible to secure the adhesion and sensor responsiveness of the protection layer 67 by prescribing in such a way that the average height H of the raised portions H is 55 μm to 75 μm.

### Working Example 3

Next, a test evaluating the adhesion (thermal durability) of the protection layer 67 and sensor responsiveness is carried out in order to confirm the efficacy of the prescription (3). In the process of manufacturing the sensor element 6, pastes 154 wherein a classification of the granular particles 151 is carried out using various mesh sieves, and the mixing ratios of the granular particles 151 and microscopic particles 152 are set to various ratios differing from one another in the same way as in Working Example 1, are prepared. The mother bodies 161 are coated with the pastes 154 and fired, thus obtaining samples of the solid electrolyte body 61. The number of raised portions 102 included in the area of 1 mm×14 mm on the surface of the leading end portion 64 of each sample is counted using a ultra-depth microscope in the same way as in Working Example 1, and samples of which the number N of raised portions 102 per mm² is 30 are extracted.

Furthermore, in the same way as in Working Example 1, the height of the raised portions 102 of each extracted sample protruding above the base portion 103 is measured to calculate the average height H. Samples of which the average height H of the raised portions 102 is 60 μm are further extracted. Further, the sensing electrode 62 and protection layer 67 are formed on each extracted samples of the solid electrolyte body 61, thus completing each sample of the sensor element 6.

Arbitrary nine samples are selected from among the completed samples and taken to be samples 3A to 3H. Images of the samples 3A to 3H photographed in the area of 1 mm×14 mm by the ultra-depth microscope are displayed again, and a visual observation of the raised portions 102 is carried out. The samples 3A, 3B, and 3F to 3H, each having 200 or more places in which a contact or overlap has occurred between adjacent raised portions 102, of the raised portions 102 included in the area, are evaluated as having variation in distribution of the raised portions 102. The samples 3C to 3E, each having less than 200 places in which a contact or overlap has occurred between adjacent raised portions 102 and thus having the raised portions 102 disposed spaced apart, are evaluated as having no variation in distribution.

Furthermore, each sample 3A to 3H is sorted into samples of which the outer diameter D (a maximum outer diameter in a direction perpendicular to the direction of protrusion) of the raised portions 102 in the heretofore mentioned area is 90 μm or more, samples of which the outer diameter D of the raised portions 102 is 45 μm to 90 μm, and samples of which the outer diameter D of the raised portions 102 is 45 μm or less, and the number of samples of each sort is counted to calculate a proportion with respect to the total number.

Next, each sample 3A to 3H is completed as the gas sensor 1, and a test evaluating sensor responsiveness, wherein an elapsed time from propane being injected until the λ value changes accordingly is measured, is carried out in the same way as in Working Example 2. Furthermore, the sensor element 6 is removed from the assembled gas sensor 1, and a test evaluating the adhesion (thermal durability) of the protection layer 67, wherein heating by a burner and room temperature cooling which are the same as in Working Example 1 is repeated, is carried out on each sample 3A to 3H. Results of the adhesion (thermal durability) and sensor responsiveness evaluation tests are shown in Table 3.

TABLE 3

| | | Granular particle size | | | | |
|---|---|---|---|---|---|---|
| | Variation in | distribution (≈raised | | | Adhesion | |
| | distribution | portion outer diameter D) | | | of spinel | |
| | of raised | 90 μm or | 90 to | 45 μm or | protection | Sensor |
| Sample | portions | more | 45 μm | less | layer | responsiveness |
| 3A | Present | 0% | 50% | 50% | Bad | Good |
| 3B | Present | 2% | 63% | 35% | Triangle | Good |
| 3C | Absent | 2% | 74% | 24% | Good | Good |
| 3D | Absent | 1% | 90% | 9% | Good | Good |
| 3E | Absent | 1% | 75% | 24% | Good | Good |
| 3F | Present | 8% | 62% | 30% | Good | Triangle |
| 3G | Present | 30% | 44% | 26% | Good | Bad |
| 3H | Present | 15% | 45% | 40% | Good | Bad |

As shown in Table 3, 70% samples of which the outer diameter D of the raised portions 102 is 45 μm to 90 μm are included in each of the samples 3C to 3E evaluated as having no variation in distribution of the raised portions 102. That is, the percentage of raised portions 102 with an outer diameter of 90 μm or more, which cause variation in the outer diameter D while contributing significantly to adhesion, and raised portions 102 with an outer diameter of 45 μm or less, which cause a decrease in adhesion while suppressing the variation, is low at less than 30% of the total. With all the samples 3C to 3E wherein distribution in the outer diameter D of the raised portions 102 concentrates totally in a range of 45 μm to 90 μm, it can be confirmed that it is possible to secure sufficient adhesion (thermal durability), and that it is possible to secure sufficient sensor responsiveness.

The samples 3A have no raised portion 102 with an outer diameter D of 90 μm or more, but have 50% raised portions 102 with an outer diameter of 45 μm to 90 μm, and 50% raised portions 102 with an outer diameter D of 45 μm or less. That is, as only raised portions 102 with an outer diameter D of less than 90 μm are uniformly distributed as a whole, it is possible to secure sensor responsiveness. However, as the raised portions 102 with an outer diameter D of 45 μm or less, which are unfavorable for adhesion, are 50%, it is not possible to secure adhesion. The samples 3H have 40% raised portions 102 with an outer diameter D of 45 μm or less, fewer than the sample 3A. That is, as the samples 3H have 60% raised portions 102 with an outer diameter of more than 45 μm, of which there are as many as 15% raised portions with an outer diameter D of more than 90 μm which contribute significantly to adhesion, it is possible to secure adhesion. However, with the samples 3H, as there are only 45% raised portions 102 with an outer diameter D of 45 μm to 90 μm, and furthermore, the remaining 55% raised portions 102 are dispersed widely all over a size range from a size of 45 μm or less to a size of 90 μm or more, sensor responsiveness decreases. With the samples 3G too, in the same way as the samples 3H, as there are many raised portions 102 with an outer diameter D of 90 μm or more, and there are fewer raised portions 102 with an outer diameter D of 45 μm or less, it is possible to secure adhesion, but as the outer diameters D of the raised portions 102 are dispersed widely all over the size range, it is not possible to secure sensor responsiveness.

With the samples 3F, the raised portions 102 with an outer diameter of 45 μm or less which are unfavorable for adhesion are 30%, substantially the same percentage as in the samples 3G, while the raised portions 102 with an outer diameter D of 90 μm or more which contribute to adhesion are 8%, fewer than in the samples 3H, but it is possible to secure adhesion. However, the raised portions 102 with an outer diameter D of 90 μm or more which cause variation are fewer at 8%, but the raised portions 102 with an outer diameter D of 45 μm to 90 μm are 62%, that is, less than 70%, and the outer diameters D are still dispersed widely, because of which it is not possible to obtain sufficient quickness as sensor responsiveness. With the samples 3B, as the raised portions 102 with an outer diameter of 90 μm or more are fewer at 2%, that is, 98% raised portions 102 have an outer diameter of less than 90 μm, the dispersion of the outer diameters D is suppressed, and sensor responsiveness improves. However, the samples 3B have 63% raised portions 102 with an outer diameter of 45 μm to 90 μm, fewer than the samples 3C having 74%, that is, 70% or more raised portions 102 with an outer diameter of 45 μm to 90 μm, and have many raised portions 102 with an outer diameter of 45 μm or less. Because of this, it is not possible to obtain sufficient anchor effect, and adhesion is insufficient. It can be confirmed from these evaluation test results that it is possible to secure the adhesion of the protection layer 67 and sensor responsiveness by prescribing in such a way as to include 70% or more raised portions 102 with an outer diameter D of 45 μm to 90 μm.

### Working Example 4

Furthermore, with regard to the regulation (3), a test of comparison with heretofore known sensor elements is carried out. The heat resistance in wet conditions evaluation test described in Working Example 1 is carried out on samples 4A to 4H satisfying all the regulations (1) to (3) and samples 4I to 4K (the heretofore known sensor elements) not satisfying at least the prescription (3). Results of the test are shown in Table 4.

TABLE 4

| | | | Granular particle | | | | | | |
|---|---|---|---|---|---|---|---|---|---|
| | Average | | size distribution | | | | | cracking in | |
| | height H | Number N | (≈raised portion | | | | | wet conditions | heat |
| | of raised | of raised | outer diameter D) | | Adhesion | Mixing ratio | | minimum | resistance |
| | portions | portions | 90 μm or | 4 5 μm or | weight | Granular | Microscopic | temperature | in wet |
| Sample | [μm] | [per mm²] | more [%] | less [%] | [mg/cm²] | particles[%] | particles[%] | [° C.] | conditions |
| 4A | 56 | 13 | 1 | 5 | 3 | 25 | 75 | 675 | Good |
| 4B | 65 | 17 | 2 | 5 | 3 | | | 675 | Good |
| 4C | 66 | 23 | 1 | 9 | 8 | | | 675 | Good |
| 4D | 68 | 23 | 1 | 9 | 8 | | | 675 | Good |
| 4E | 62 | 32 | 1 | 15 | 8 | | | 675 | Good |
| 4F | 68 | 28 | 1 | 10 | 8 | | | 675 | Good |
| 4G | 61 | 30 | 5 | 20 | 12 | | | 625 | Good |
| 4H | 73 | 46 | 8 | 15 | 12 | | | 625 | Good |
| 4I | 56 | 48 | 8 | 30 | 15 | 40 | 60 | 575 | Bad |
| 4J | 58 | 55 | 30 | 26 | 25 | | | 525 | Bad |
| 4K | 60 | 76 | 15 | 40 | 15 | | | 575 | Bad |

As shown in Table 4, the samples 4A to 4H, being such that the average heights H of the raised portions 102 are all included in a range of 55 μm to 75 μm, satisfy the prescription (2). Also, the samples 4A to 4H, being such that the numbers N of raised portions 102 per mm² are all included in a range of 10 to 50, satisfy the prescription (1). Furthermore, all the samples 4A to 4H, being such that the number of raised portions 102 with an outer diameter D of 45 μm<D<90 μm is 70% or more of the total number, satisfy the prescription (3). With all these samples 4A to 4H, as a crack has occurred at 625° C. or more, and in particular, with the samples 4A to 4F, as a crack has occurred at 675° C. or more, it can be confirmed that it is possible to obtain sufficient heat resistance in wet conditions.

Meanwhile, with all the samples 4I not satisfying the prescription (3) and samples 4J and 4K not satisfying either the prescription (1) or (3), as a crack has occurred at 575° C., it is not possible to obtain sufficient heat resistance in wet conditions. In particular, with the samples 4J, a crack has occurred at 525° C.

### DESCRIPTION OF REFERENCE NUMERALS AND SIGNS

1 Gas sensor
3 Metal pipe
5 Metal shell
6 Sensor element
18 Lead wire
61 Solid electrolyte body
62 Sensing electrode
63 Reference electrode
67 Protection layer
101 Adhesion layer
102 Raised portion
103 Base portion

1. A gas sensor element, characterized by comprising: a bottomed cylindrical solid electrolyte body closed at the leading end; an inner side electrode and outer side electrode provided respectively on the inner surface and outer surface of the solid electrolyte body; a protection layer which covers and protects the outer side electrode; an adhesion layer, forming a surface layer of the solid electrolyte body, including by a plurality of raised portions, and positioned in at least one portion of the solid electrolyte body outer surface corresponding to the protection layer, the gas sensor element detecting a specified gas component in gas to be measured, wherein
the adhesion layer has the raised portions and a base portion from a surface of which the raised portions are protruded,
when the number of raised portions formed per mm² on the surface of the base portion is taken to be N, 10≦N≦50,
when the average of the heights of the raised portions protruding above the surface of the base portion in a direction perpendicular to the surface of the base portion is taken to be H, 55≦H≦75 [μm], and
when the outer diameter of the raised portions is taken to be D, the number of raised portions with 45<D<90 [μm] is 70% or more of the total number.

2. A gas sensor, characterized by comprising:
the gas sensor element as claimed in claim 1;
a metal shell which holds the gas sensor element by enclosing a radial periphery of the gas sensor element;
a metal pipe, whose leading end side is fixed to the metal shell, enclosing a rear end side radial periphery of the gas sensor element; and
a pair of lead wires, connected one each to the pair of electrodes inside the metal pipe, which extract an output of the gas sensor element to the exterior.
